(19) United States
(12) Patent Application Publication
(10) Pub. No.: US 2019/0080061 A1
(43) Pub. Date: Mar. 14, 2019

(54) METHOD FOR SECURE KEY INPUT

(71) Applicant: H & BIT CO., LTD., Daejeon (KR)

(72) Inventor: Ky Young BAEK, Daejeon (KR)

(73) Assignee: H & BIT CO., LTD., Daejeon (KR)

(21) Appl. No.: 16/190,850

(22) Filed: Nov. 14, 2018

Related U.S. Application Data
(63) Continuation of application No. PCT/KR2017/015253, filed on Dec. 21, 2017.

(30) Foreign Application Priority Data
Dec. 29, 2016 (KR) 10-2016-0182017

(51) Int. Cl. G06F 21/31; G06F 21/45; G06F 21/83

(52) U.S. Cl. CPC G06F 21/31; G06F 21/83; G06F 21/45

(57) ABSTRACT

The present invention relates to a method for secure key input that enables key input of a unit value of authentication information without any change in a user terminal and has a usability, and further, enforces a security for authentication information of a user by preventing leakage of authentication information by server hacking fundamentally as well as preventing leakage of authentication information in the whole processes including a key value obtaining process of the user terminal, a key value transport process and an authentication process at a server. According to the present invention, alternative authentication information that replaces authentication information is used, a mapping value to be matched to a key of keyboard is randomly generated and used, and authentication procedure is performed using the authentication information which is randomly generated according to the alternative authentication information.

### CROSS-REFERENCE TO RELATED APPLICATION

This U.S. non-provisional patent application is a Continuation of International Application No. PCT/KR2017/015253 filed Dec. 21, 2017, which claims priority under 35 U.S.C. § 119 of Korean Patent Application No. 10-2016-0182017 filed Dec. 29, 2016, the entire contents of which are hereby incorporated by reference.

### BACKGROUND OF THE INVENTION

### Field of the Invention

The present invention relates to a method for secure key input that enables key input of a unit value of authentication information without any change in a user terminal and has a usability, and further, enforces a security for authentication information of a user by preventing leakage of authentication information by server hacking fundamentally as well as preventing leakage of authentication information in the whole processes including a key value obtaining process of the user terminal, a key value transport process and an authentication process at a server.

### Related Art

A keyboard of a user terminal processes a key input of a user using a keyboard, a key pad and a virtual keyboard implemented on a touch recognition type display in GUI format, and there is possibility of leaking authentication information by leakage by, so called, the shoulder surfing or key logging in the process of inputting and transmitting the authentication information such as a password, an access number, an account access number, a security card number, and the like by accessing a server that provides a service such as internet banking.

Accordingly, a security has been enforced by the scheme of changing the mapping value on the keyboard, which was fixed to a mapping value intended to be used as a key value that processes input by a key push, to an arbitrary value or the scheme of changing key arrangement by implementing a keyboard on a displayer.

However, in the aspect of a user, when the user uses various types of services, the user has to remember and use authentication information for each service, and there is a possibility of wrong input when key arrangement is changed. Since the number of wrong inputs is restricted generally, there has been inconvenience in use.

In addition, the authentication information is also stored and used in a service providing server, and accordingly, there is a problem that the authentication information may be used maliciously when the authentication information is leaked through any paths from a user terminal or a server or during transmission processes.

### PRIOR ART DOCUMENT

### Patent Document

(Patent document 1) KR 10-0960517 B1 May 24, 2010

(Patent document 2) KR 10-0975854 B1 Aug. 9, 2010

### SUMMARY OF THE INVENTION

Accordingly, the present invention is to provide a method for security key input that provides an enforced security for leakage by the shoulder surfing as well as prevents the whole processes including a key value processing process in a user terminal, a transport process and an authentication process at a server.

In order to attain the object, the present invention includes a method for secure key input performed by an authentication server 10 for security of authentication information, when the authentication information is input through a keyboard in which an intrinsic mapping value is visibly displayed on a key, wherein the intrinsic mapping value is matched to each key of a user terminal 20 that is remotely accessed and has the intrinsic mapping value as its key value, a registration step (S10) for storing alternative authentication information in which key position information to which the intrinsic mapping value which is identical to each unit value of the authentication information is matched and order information of unit values of the authentication information are encrypted; a mapping value generation step (S20) for generating a random mapping value to be matched to each key position of the keyboard and designating sequence of the random mapping value obtained based on the key position information obtained by decoding the alternative authentication information among the generated random mapping values and the order information of unit values of the authentication information; a mapping value switching step (S30) for substituting the intrinsic mapping value by the random mapping value by transmitting the random mapping value to the user terminal; an input value reception step (S40) for receiving the sequence of the random mapping value obtained when a key on which each unit value of the authentication information is displayed in the user terminal is pushed as a key value; and an authentication step (S50) for mutually authenticating by comparing the received sequence of the random mapping value and the random authentication information.

In an embodiment of the present invention, the mapping value generation step (S20) is performed by a program of an execution file format in which generating the random mapping value and designating the random authentication information are performed sequentially and consecutively.

In an embodiment of the present invention, the key position information encrypted by the alternative authentication information and the order information of unit values of the authentication information have a data format different from a data format of the intrinsic mapping value, and are used for designating the random authentication information by decoding the alternative authentication information in the program performed for performing the mapping value generation step (S20).

In an embodiment of the present invention, the random mapping value for each key in the mapping value generation step (S20) is generated by a process of randomly selecting as much as a number of the keys of the keyboard among codes displayed in a specific data format and a process of matching the selected codes to the keys of the keyboard in one-to-one manner by arranging the selected codes randomly.

In an embodiment of the present invention, the specific data format is selected by a process of randomly selecting one of a plurality of data formats.

In an embodiment of the present invention, the plurality of data formats is a data format which is different from the data format of the intrinsic mapping value.

In an embodiment of the present invention, in the mapping value generation step (S20), the random authentication information is obtained in accordance with the keyboard of the user terminal 20 by designating the random authentication information by applying the key position information in which the key position information obtained by decoding the alternative authentication information is corrected according to keyboard information, after obtaining the keyboard information of the user terminal 20 in which key arrangement is different according to a type of keyboard.

In an embodiment of the present invention, the alternative authentication information in the registration step (S10) is stored for each keyboard type based on key position information different for each keyboard type, and wherein the mapping value generation step (S20) designates the random authentication information obtained according to the alternative authentication information that corresponds to a type of keyboard which is obtained from the keyboard type of the user terminal 20.

According to the present invention embodied as described above, even in the case that a key input of authentication information of a user is performed without any change, a leakage of authentication information by hacking at a server is prevented, and accordingly, safely used. In addition, a key mapping value which is randomly generated is used whenever an authentication process is performed by accessing a server, and accordingly, the whole processes including a key value processing process, a transport process and an authentication process may be prevented.

### BRIEF DESCRIPTION OF THE DRAWINGS

FIG. 1 is a block diagram illustrating an authentication server 10 for a method for secure key input according to an embodiment of the present invention.

FIG. 2 is a flowchart of a method for secure key input according to an embodiment of the present invention.

FIG. 3 is a flowchart of a detailed embodiment illustrating a procedure of authenticating an account access number according to a method for secure key input according to an embodiment of the present invention.

### DESCRIPTION OF EXEMPLARY EMBODIMENTS

In describing the embodiment of the present invention, the mapping value corresponding to a key value for a key input by visibly displaying each key of a keyboard 21 is referred to as an intrinsic mapping value and the mapping value randomly generated in order to match a key input to each key which is generated in an authentication server is referred to as a random mapping value, and thus, the mapping values are distinguished.

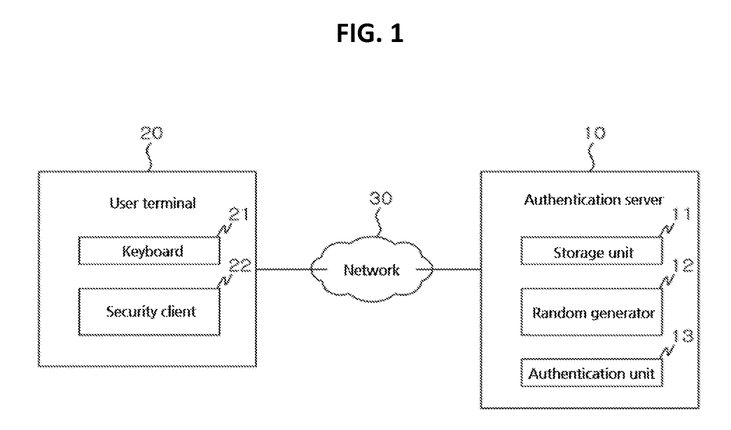

Referring to FIG. 1, an authentication server 10 for a method for secure key input according to an embodiment of the present invention includes a storage unit 11 that enables to perform an authentication procedure while keeping security for authentication information input through a keyboard 21 by installing a security client 22 for exchanging a mapping value in a user terminal 20 intended to being served that remotely accesses through a network 30, and stores alternative authentication information substituting the authentication information therefor, a random generator that randomly generates a random mapping value set to be matched to the keyboard 21 and random authentication information corresponding to the alternative authentication information, and an authentication unit 13 that transmits the random mapping value set randomly generated to a security client 22 of the user terminal 20 such that the random mapping value set is used instead of the intrinsic mapping value, receives a random mapping value input from a key value according to a key input and compares with a unit value of the random authentication information and authenticates, and provides a requested service after the authentication.

Here, an example of the service to be provided by the authentication server 10 includes an internet banking service, and an example of the authentication information includes a password, an access number (or an account access number), a security card number, and the like.

In the user terminal 20, an example of the keyboard 21 includes a keyboard and that of being implemented on a touch recognition type displayer in GUI format. The types of the keyboard 21 are various, and a key arrangement thereof may be changed according to the types of the keyboard 21. Since the input of the keyboard 21 is processed with a mapping value matched to a pushed key as a key value like the conventional keyboard, the keyboard 21 is processed with an intrinsic mapping value matched to a pushed key as a key value when the mapping value is the intrinsic mapping value and processed with a random mapping value matched to a pushed key when the mapping value is the random mapping value.

In addition, the intrinsic mapping values are marked on keys when a keyboard is manufactured, otherwise, in the case that a keyboard is exposed in GUI format on a displayer, the intrinsic mapping values are displayed on keys in the scheme that the intrinsic mapping values are displayed together, the key on which the intrinsic mapping value matched to authentication information is displayed may be pushed.

The security client 22 of the user terminal 20 may be performed by a program or an application for security of a key input which is provided to or installed in the user terminal 20 by the authentication unit 13 of the authentication server 10, and for example, may be implemented on a web browser when the user terminal 20 accesses to the authentication server 10 through web for internet banking.

According to the present invention, the security client 22 substitutes the intrinsic mapping value set to the random mapping value set while authentication process is performed to be used, and an input of the key value output when each key is pushed is processed as a value of the random mapping value set and transmitted to the authentication server 10.

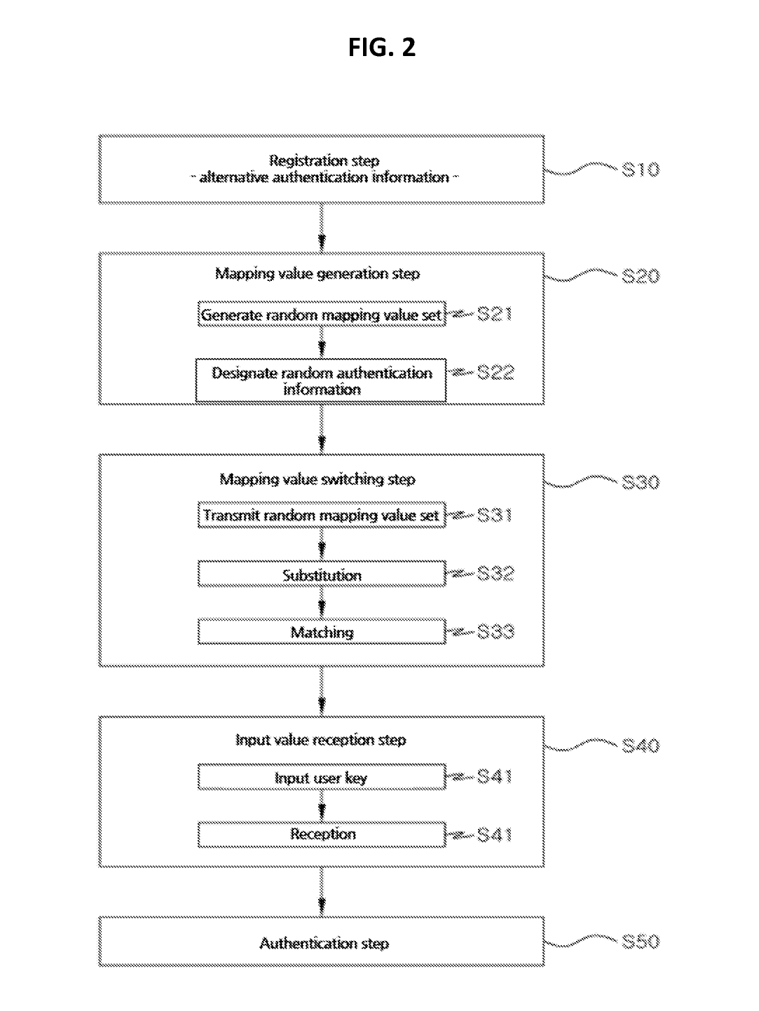

Hereinafter, a method for secure key input performed by the storage unit 11 provided in the authentication server 10, the random generator 12 and the authentication unit 13 is described with reference to the flowchart of FIG. 2.

According to the flowchart of FIG. 2, the method for secure key input includes a registration step (step, S10) for storing encrypted alternative authentication information for authentication information of a user in the storage unit 11; a mapping value generation step (step, S20) for generating a random mapping value set to be matched to each key position of a keyboard in the random generator 12 (step, S21) and designating a random mapping value including sequence of random mapping values obtained based on the information obtained by decoding the alternative authentication information among the generated random mapping value set (step, S22); a mapping value switching step (step, S30) for substituting the intrinsic mapping value so as to be used as the mapping value set of the keyboard 21 by the random mapping value set to the user terminal 20 through the network 30 by the authentication unit 13; an input value reception step (step, S40) for receiving the sequence of the random mapping value obtained (step, S42) as a keyboard key input in the user terminal 20 (step, S41) by the authentication unit 13; and an authentication step (step, S50) for mutually authenticating by comparing the sequence of the random mapping value received in the authentication unit 13 and the random authentication information.

In the registration step (step, S10), the alternative authentication information stored in the storage unit is the information that encrypts the key position information to which the intrinsic mapping value identical to each unit value of the authentication information is matched and the key matching information of the authentication information including list order information of the unit values in the authentication information. That is, the alternative authentication information is the information that encrypts the sequence of the position information on which each unit value of the authentication information is displayed on the keyboard 21.

Accordingly, when the alternative authentication information is decoded, the key position information and the order information on the keyboard corresponding to each unit value of the authentication information may be known. Here, when the intrinsic mapping value set is matched to the keyboard 21, user authentication information may be obtained using the position information, and accordingly, it is preferable that the position information in this case does not correspond to the mapping value of the intrinsic mapping value set, but a code value of different data format is used, and the alternative authentication information that encrypts the code value is used.

The mapping value of each random mapping value of the random mapping value set generated in the mapping value generation step (step, S20) is generated so as to have different values.

The random mapping value set at this time may be randomly selected in a predetermined specific data format, but it is also available that one of a plurality of data formats is selected and a code that may be displayed among the selected data formats is randomly selected.

Since there are various data formats such as Korean letters, English letters, special characters, numbers, color codes, and so on, it is preferable that the data format is randomly selected among the data formats. It is more preferable that the data format is randomly selected among the data formats different from the data format (i.e., the data format of the intrinsic mapping value which was matched to the key used when the authentication information is inputted through the keyboard) allowed as an intrinsic nit value.

For example, in the case of a number key, a code of any one data expression format or a code in which two or more data expression formats are mixed is selected among Korean letter code, English letter code, special character code, and color codes.

That is, in the case of using the data format in which a data format is allowed as the intrinsic unit value, for example, in the case that only a number is allowed as each unit value of the authentication information, it is good for generating a random sequence as much as the number of number keys among the keys on the keyboard and generating a random mapping value set that is going to be one-to-one matched to the number keys, but is preferable that other data format is selected and applied for enforcing security.

After the data format is selected as such, the random mapping value set is obtained by sequentially performing a process of randomly selecting as much as the number of the keys of the keyboard among code values that may be displayed in the selected data format and a process of matching the selected codes to the keys of the keyboard in one-to-one manner by arranging the selected codes randomly.

And, by decoding the alternative authentication information, the key matching information of the authentication information including the key position on the keyboard matched to each unit value of the authentication information and the key matching information of the authentication information including the unit value order information is obtained, and accordingly, a sequence of the random mapping value corresponding to the key matching information is obtained from the random mapping value set, and the sequence of the obtained random mapping value is designated as the random authentication information.

Here, the series of the processes including the process of generating the random mapping value set and the process of designating the random authentication information by selecting among the random mapping value set are sequentially and consecutively performed by a program.

That is, the random authentication information is obtained, which has a format different from the intrinsic authentication information using the alternative authentication information, and this leaves nothing to obtain the authentication information even in the case that the alternative authentication information is hacked. Since the alternative authentication information is generated and changed every time when the random mapping value set is generated simultaneously, the authentication information is not obtainable even in the case that the random mapping value set is hacked.

In addition, it is beneficial that the program is stored and used as an execution file format such that security is enforced.

That is, the key position information and the authentication information unit value order information encrypted by the alternative authentication information have a data format different from the data format of the intrinsic mapping value and are used when the random authentication information is designated by decoding the alternative authentication information in the program performed for performing the mapping value generation step (step, S20), and accordingly, not leaked by hacking.

As such, by generating and using the random authentication information and the random mapping value set which are changed whenever an authentication procedure is performed, security may be enforced at a server for the authentication information.

In the input value reception step (step, S40), when the user pushes a key on the keyboard 21 (step, S411), each unit value of the authentication information are inputted according to the order as the value displayed as the intrinsic mapping set value on the keyboard 21, but the security client 22 performs an input process of the random mapping value matched to the pushed key among the random mapping value set received from the authentication server as the key value, and transmits the random mapping value sequence which is input-processed to the authentication server 10.

Accordingly, the user may input key in accordance with the intrinsic mapping value displayed on the key of the authentication information that the user uses without any change, miss input may be decreased, which may occur frequently when the scheme is used that the mapping arrangement change of the intrinsic mapping value set is displayed in GUI format on the conventional touch recognition type display and a key is pushed accordingly, and there is a convenience in use that input is performed in accordance with the mark of the key in the aspect of the user.

In addition, the authentication information used by the user is never exposed until the transmission procedure to the authentication server 10 and the authentication procedure in the authentication server 10 after the key input in the user terminal 20, and furthermore, the authentication information cannot be obtained from the alternative authentication information stored for authentication and the random authentication information generated for authentication, and accordingly, security may be more enforced in comparison with the conventional art focused on the security of key input process in the user terminal 20.

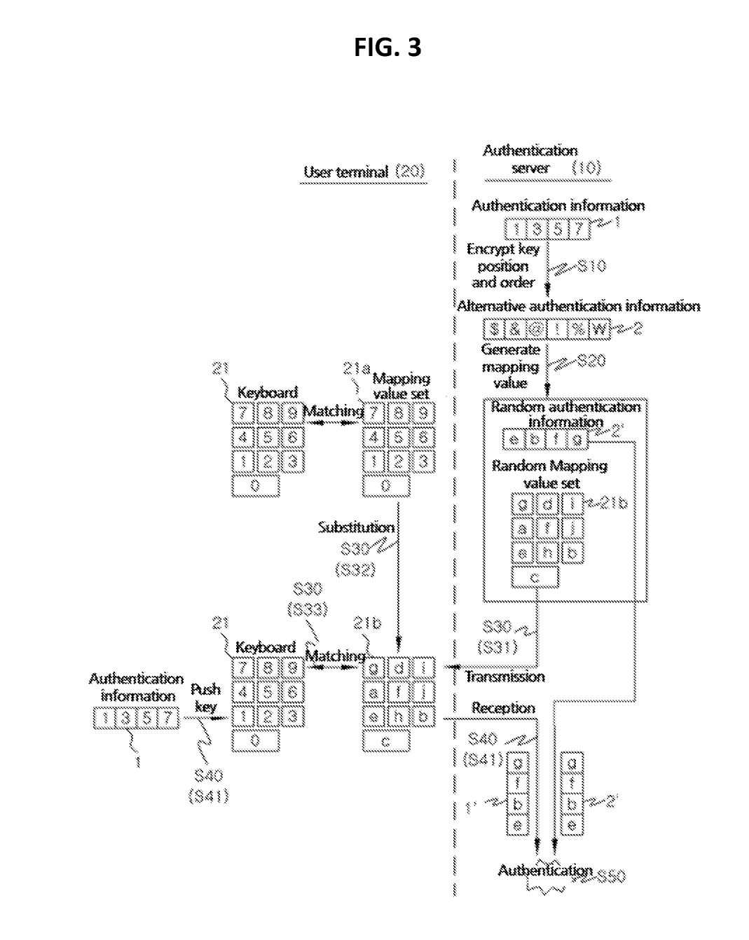

The detailed embodiment for the method for secure key input according to the embodiment of the present invention is described with reference to FIG. 3.

FIG. 3 is a diagram illustrating an authentication procedure when a user uses an account transfer service after a user having a band account, in which authentication information 1 is ‘1357’ as an account access number allowed only numbers of the authentication information 1, accesses and log-in the authentication server 10 for internet banking.

In addition, ‘$&@!%\’ that encrypts the authentication information 1 is registered and stored in the authentication server 10 as the alternative authentication information 2 (step, S10). The alternative authentication information 2 at this time encrypts the key matching information, that is, the key position information to which the intrinsic mapping value identical to each unit value of the authentication information 1 is matched and the unit value order information, and exemplified by a code value of special character, but it is also beneficial that a code of data format different from it is used.

A number pad provided in a right side of the conventional keyboard is exemplified as the keyboard 21 of the user terminal 20, but the implementation of the key pad on the touch recognition type display in GUI format may also be used. However, an intrinsic mapping value set 21a indicating the intrinsic mapping value matched to each key in one-to-one manner is predetermined, and the matched intrinsic mapping value is displayed on each key which is visible by the user's eye.

During the process of providing the account transfer service, the authentication server 10 generates a random mapping value set 21b and random authentication information 2′ by performing the mapping value generation step (step, S20) to perform the process of inputting the authentication information 1.

In this embodiment, the random mapping value set 21b is that different English alphabet letters are randomly selected as much as the number of keys of the keyboard among the English alphabet letters, and randomly arranged and correspond to keys one by one.

That is, the random mapping value set 21b includes the key position information to which each random mapping value is matched.

Of course, the random mapping value set 21b may be selected by a code of data of different format such as Korean consonants and vowels, coder codes, and the like, instead of the English alphabet letters. In addition, it is beneficial that the random mapping value set 21b is obtained by performing a series of processes including randomly selecting a data format, randomly selecting the number of required number (key number of the keyboard) among a plurality of code values of the selected data format, randomly arranging the code values of the selected number, and matching the arrangement on the key positions of the keyboard in one-to-one manner.

Since the random authentication information 2′ is a random mapping value sequence extracted from the random mapping value set 21b according to the key position information obtained by decoding the alternative authentication information 2 ‘$&@!%\’ and the selection order of each position, the mapping values e, b, f and g of the position corresponding to each unit value 1, 3, 5 and 7 of the authentication information 1 ‘1357’ is extracted from the random mapping value set 21b, and corresponds to ‘ebfg’.

In addition, the mapping value set 21b is transmitted to the user terminal 20 (step, S31) and alternatively used by substituting the existing intrinsic mapping value set 21a (step, S32), and accordingly, the keyboard 21 of the user terminal 20 is matched to the random mapping value set 21b (step, S33), and thus, when a key is pushed, an input of the random mapping value matched to the pushed key is processed as a key value.

As such, in the state that it is ready to input the authentication information 1, when the user pushes the keys on which unit values of 1, 2, 3 and 4 of the authentication information ‘1357’ that the user memorizes sequentially (step, S41), the user terminal 20 processes the input of the random mapping values e, b, f and b that correspond to the sequentially pushed keys, and obtains the input value 1′ ‘ebfb’ constructed by a random mapping value sequence.

At this time, the authentication server 10 receives the input value 1′ ‘ebfb’ from the user terminal 20 (step, S41), and compares the random authentication information 2′ with the input value 1′ and checks up whether each unit value is identical sequentially, and then, the values are identical, processes authentication, thereby providing the account transfer service.

According to the detailed embodiment exemplified in FIG. 3, the authentication server 10 does not store the authentication information 1 and does not even store temporarily the authentication information 1 during the authentication procedure, and accordingly, security of the authentication information 1 may be kept at a server end. Further, the authentication information 1 is not also be used during the process of transmitting the authentication information 1 to the authentication server 10 after the key input and the process of authenticating, security during the key input process, the transmission process and the authentication process is also kept.

According to the present invention, it is allowed that the user pushes keys in accordance with the values of the authentication information 1 shown on the keyboard 21, and accordingly, input is processed conveniently without miss input, and security of the whole processes including security at a server end, security during authentication process, and the like may be kept.

Meanwhile, there are various types of the keyboard 21 including a keyboard connected to a PC through PS2 or USB port, a virtual keyboard displayed in GUI format on a displayer, a physical keypad on a mobile terminal or various types of keyboards implemented by a graphical keyboard displayed on a touch screen (Heaven-Earth-Human keyboard, National-letter keyboard, Sky keyboard, etc.). As an example of a number key input, since keys are arranged in different arrangement exemplified in FIG. 3 and there are differences in key type, size, display area when displayed on a displayer, each of key position information may be changed depending on the keyboard types.

Accordingly, in the case that the key position information is the information for the key position on the keyboard, the key position information to which the intrinsic mapping value identical to each unit value of the authentication information is also changed depending on the keyboard types. That is, it is beneficial to set the key position information as the intrinsic mapping value, but for enforcing security, the key position information corresponding to the authentication information in the case of the key position on the keyboard is also changed depending on the keyboard types.

Accordingly, in the case that the key position information to which the intrinsic mapping value identical to each unit value of the authentication information is matched is obtained from the key arrangement of any one type of keyboards and the alternative authentication information is generated and registered, the key position information obtained by decoding the alternative authentication information in the mapping value generation step (step, S20) should be corrected, and the random authentication information obtained according to the corrected key position information should be designated.

For this, the mapping value generation step (step, S20) includes a correction step that corrects the key position information obtained by decoding the alternative authentication information according to keyboard information, after the keyboard information including key arrangement of the user terminal 20 is acquired. Of course, it is beneficial to make an execution program such that the execution program of a random generator uses the information for differences of key arrangement for each keyboard type, that is, the information for correction of the key position information according to difference of keyboard.

Here, the acquisition of the keyboard information may be performed in the scheme that the information of keyboard used in the user terminal 20 is received from the user terminal 20, and in the case that a graphical keyboard is used, which is generated by the authentication unit 13 and displayed on the screen of the user terminal 20, the keyboard information may be acquired from the authentication unit 13 directly.

As another embodiment, in the registration step (step, S10), based on the key position information different for each keyboard type, the key position information corresponding to each unit value of the authentication information is obtained for each of the various keyboard types, and the alternative authentication information for each keyboard type may be generated and registered. That is, the key position information corresponding to the authentication information becomes changed for each keyboard type, and the authentication information in which the key position information is encrypted together with the order information of the authentication information unit value becomes also changed for each keyboard type.

In this case, in the mapping value generation step (step, S20), the keyboard type of the user terminal 20 is obtained, the alternative authentication information corresponding to the obtained keyboard type is selected among the alternative authentication information for each keyboard type, and the random authentication information is obtained and designated according to the selected alternative authentication information.

According to the present invention embodied as described above, even in the case that a key input of authentication information of a user is performed without any change, a leakage of authentication information by hacking at a server is prevented, and accordingly, safely used. In addition, a key mapping value which is randomly generated is used whenever an authentication process is performed by accessing a server, and accordingly, the whole processes including a key value processing process, a transport process and an authentication process may be prevented.

### DESCRIPTION OF REFERENCE NUMERALS

10: Authentication server

11: Storage unit, 12: Random generator, 13: Authentication unit

20: User terminal

21: Keyboard, 22: Security client

30: Network

What is claimed is:

1. A method for secure key input performed by an authentication server (10) for security of authentication information, when the authentication information is input through a keyboard in which an intrinsic mapping value is visibly displayed on a key, wherein the intrinsic mapping value is matched to each key of a user terminal (20) that is remotely accessed and has the intrinsic mapping value as its key value,
a registration step (S10) for storing alternative authentication information in which key position information to which the intrinsic mapping value which is identical to each unit value of the authentication information is matched and order information of unit values of the authentication information are encrypted;
a mapping value generation step (S20) for generating a random mapping value to be matched to each key position of the keyboard and designating sequence of the random mapping value obtained based on the key position information obtained by decoding the alternative authentication information among the generated random mapping values and the order information of unit values of the authentication information;
a mapping value switching step (S30) for substituting the intrinsic mapping value by the random mapping value by transmitting the random mapping value to the user terminal;
an input value reception step (S40) for receiving the sequence of the random mapping value obtained when a key on which each unit value of the authentication information is displayed in the user terminal is pushed as a key value; and
an authentication step (S50) for mutually authenticating by comparing the received sequence of the random mapping value and the random authentication information.

2. The method for secure key input of claim 1, wherein the mapping value generation step (S20) is performed by a program of an execution file format in which generating the random mapping value and designating the random authentication information are performed sequentially and consecutively.

3. The method for secure key input of claim 2, wherein the key position information encrypted by the alternative authentication information and the order information of unit values of the authentication information have a data format different from a data format of the intrinsic mapping value, and are used for designating the random authentication information by decoding the alternative authentication information in the program performed for performing the mapping value generation step (S20).

4. The method for secure key input of claim 1, wherein the random mapping value for each key in the mapping value generation step (S20) is generated by a process of randomly selecting as much as a number of the keys of the keyboard among codes displayed in a specific data format and a process of matching the selected codes to the keys of the keyboard in one-to-one manner by arranging the selected codes randomly.

5. The method for secure key input of claim 4, wherein the specific data format is selected by a process of randomly selecting one of a plurality of data formats.

6. The method for secure key input of claim 5, wherein the plurality of data formats is a data format which is different from the data format of the intrinsic mapping value.

7. The method for secure key input of claim 1, wherein, in the mapping value generation step (S20), the random authentication information is obtained in accordance with the keyboard of the user terminal (20) by designating the random authentication information by applying the key position information in which the key position information obtained by decoding the alternative authentication information is corrected according to keyboard information, after obtaining the keyboard information of the user terminal (20) in which key arrangement is different according to a type of keyboard.

8. The method for secure key input of claim 1, wherein the alternative authentication information in the registration step (S10) is stored for each keyboard type based on key position information different for each keyboard type, and wherein the mapping value generation step (S20) designates the random authentication information obtained according to the alternative authentication information that corresponds to a type of keyboard which is obtained from the keyboard type of the user terminal (20).
